(19) United States
(12) Patent Application Publication
(10) Pub. No.: US 2026/0145231 A1
(43) Pub. Date: May 28, 2026

(54) Additive Manufacturing Powder And Additively Manufactured Body

(71) Applicant: SEIKO EPSON CORPORATION, Tokyo (JP)

(72) Inventors: Keisuke AIDA, Hachinohe (JP); Keisuke ITOTSUBO, Hachinohe (JP)

(21) Appl. No.: 19/401,739

(22) Filed: Nov. 26, 2025

(30) Foreign Application Priority Data
Nov. 28, 2024 (JP) 2024-207307

(51) Int. Cl. B22F 1/052; B22F 1/065; B22F 10/14; B33Y 70/00; B33Y 80/00

(52) U.S. Cl. CPC B22F 1/052; B22F 1/065; B33Y 70/00; B33Y 80/00; B22F 10/14; B22F 2301/35; B22F 2303/01; B22F 2304/10

(57) ABSTRACT

An additive manufacturing powder used for manufacturing an additively manufactured body is provided: in which
a particle diameter D50, at which the cumulative frequency is 50% from the small diameter side, in a cumulative particle size distribution on a volume basis obtained by using a laser diffraction type particle size distribution measuring apparatus, is 1.0 μm or more and 10.0 μm or less;
a particle diameter D90, at which the cumulative frequency is 90% from the small diameter side, in the cumulative particle size distribution, is 11.0 μm or more and 25.0 μm or less;
a specific surface area is 0.30 m²/g or less;
a number ratio of particles having a circularity of 0.750 or more and 0.950 or less is 70.0% or more; and
a coefficient of variation of circularity of particles, obtained by dividing a standard deviation of circularity of the particles by the average circularity, is 15.0% or less.

The present application is based on, and claims priority from JP Application Serial Number 2024-207307, filed Nov. 28, 2024, the disclosure of which is hereby incorporated by reference herein in its entirety.

### BACKGROUND

### 1. Technical Field

The disclosure relates to an additive manufacturing powder and an additively manufactured body.

### 2. Related Art

As a technique for modeling a three-dimensional object, an additive manufacturing method using a metal powder is widely used in recent years. Among these, a powder bed fusion method and a binder jet method include forming a powder layer, and forming a three-dimensional powder shaped article by melting or binding the particles to each other in a part of the powder layer. The powder shaped article formed by binding the particles to each other is then subjected to sintering treatment, resulting in a metal sintered body.

JP-A-2023-093892 discloses a metal powder for additive manufacturing including metal particles, in which a particle diameter D50 is 3.0 μm or more and 30.0 μm or less, a ratio D90/D50 of a particle diameter D90 to the particle diameter D50 is 2.00 or less, and a volume ratio of the metal particles having a circularity of 0.60 or less is 2.0% or less. The particle diameter D50 is a particle diameter at which the cumulative frequency is 50% in the volume-based particle size distribution of the metal particles, and the particle diameter D90 is a particle diameter at which the cumulative frequency is 90%. By using the metal powder for additive manufacturing, a dense shaped article having excellent surface properties and fewer shaping defects can be manufactured.

JP-A-2023-093892 is an example of the related art.

However, the metal powder for additive manufacturing described in JP-A-2023-093892 has room for improvement from the viewpoint of the fillability of the powder layer. When the fillability of the powder layer is low, it is impossible to sufficiently enhance the density and dimensional accuracy in a metal melt-shaped article obtained by melting particles with each other or a metal sintered body obtained by sintering particles with each other.

Therefore, an object is to provide the additive manufacturing powder that has good flowability and fillability and can form the dense powder layer.

### SUMMARY

An additive manufacturing powder according to an application example of the present disclosure is an additive manufacturing powder used for manufacturing an additively manufactured body: in which
a particle diameter D50, at which the cumulative frequency is 50% from the small diameter side, in a cumulative particle size distribution on a volume basis obtained by using a laser diffraction type particle size distribution measuring apparatus, is 1.0 μm or more and 10.0 μm or less;
a particle diameter D90, at which the cumulative frequency is 90% from the small diameter side, in the cumulative particle size distribution, is 11.0 μm or more and 25.0 μm or less;
a specific surface area is 0.30 m²/g or less;
a number ratio of particles having a circularity of 0.750 or more and 0.950 or less is 70.0% or more; and
a coefficient of variation of circularity of particles, obtained by dividing a standard deviation of circularity of the particles by the average circularity, is 15.0% or less.

An additively manufactured body according to an application example of the present disclosure includes:
the additive manufacturing powder according to the application example of the present disclosure; and
a binder that binds particles of the additive manufacturing powder to each other.

### BRIEF DESCRIPTION OF THE DRAWINGS

FIG. 1 is a process diagram illustrating a method for manufacturing an additively manufactured body.

FIG. 2 is a diagram illustrating the method for manufacturing the additively manufactured body illustrated in FIG. 1.

FIG. 3 is a diagram illustrating the method for manufacturing the additively manufactured body illustrated in FIG. 1.

FIG. 4 is a diagram illustrating the method for manufacturing the additively manufactured body illustrated in FIG. 1.

FIG. 5 is a diagram illustrating the method for manufacturing the additively manufactured body illustrated in FIG. 1.

FIG. 6 is a diagram illustrating the method for manufacturing the additively manufactured body illustrated in FIG. 1.

FIG. 7 is a diagram illustrating the method for manufacturing the additively manufactured body illustrated in FIG. 1.

FIG. 8 is a diagram illustrating the method for manufacturing the additively manufactured body illustrated in FIG. 1.

FIG. 9 is a diagram illustrating the method for manufacturing the additively manufactured body illustrated in FIG. 1.

FIG. 10 is a diagram illustrating the method for manufacturing the additively manufactured body illustrated in FIG. 1.

FIG. 11 is Table 1 showing the steel types of each additive manufacturing powder.

FIG. 12 is Table 2 showing the configuration and evaluation results of each additive manufacturing powder.

FIG. 13 is Table 3 showing the configuration and evaluation results of each additive manufacturing powder.

FIG. 14 is Table 4 showing the configuration and evaluation results of each additive manufacturing powder.

### DESCRIPTION OF EMBODIMENTS

Hereinafter, an additive manufacturing powder and an additively manufactured body according to the present disclosure will be described in detail based on an embodiment illustrated in the accompanying drawings.

### 1. Method for Manufacturing Additively Manufactured Body

First, a method for manufacturing the additively manufactured body using the additive manufacturing powder will be described.

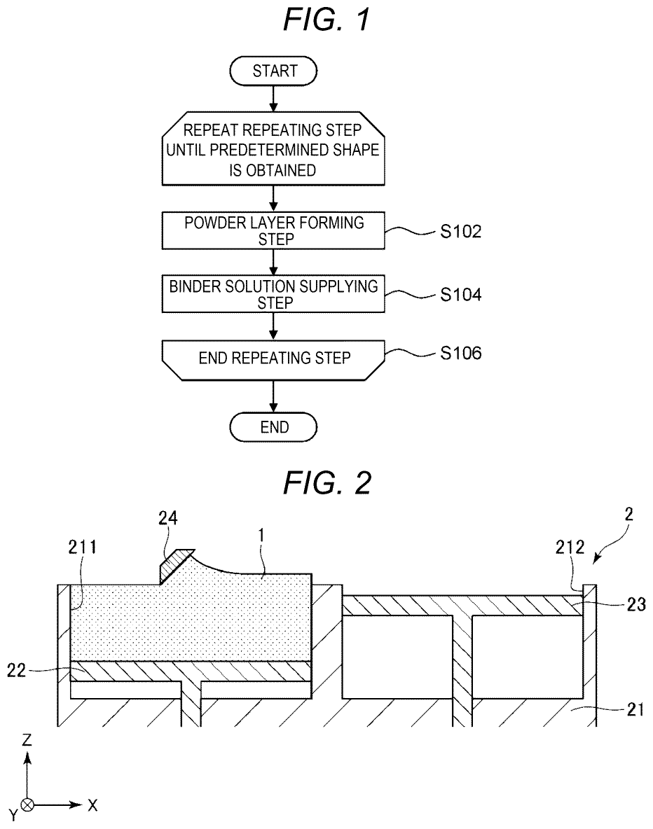

FIG. 1 is a process diagram illustrating a method for manufacturing the additively manufactured body. FIGS. 2 to 10 each illustrate the method for manufacturing the additively manufactured body illustrated in FIG. 1. In FIGS. 2 to 10, three axes orthogonal to each other are set as an X-axis, a Y-axis, and a Z-axis. Each axis is indicated by an arrow, and a tip side thereof is referred to as a “plus side” whereas a base side thereof is referred to as a “minus side”. In the following description, in particular, a plus side of the Z-axis is referred to as “upper”, and a minus side of the Z-axis is referred to as “lower”. In addition, both directions parallel to the X axis are referred to as an X-axis direction, both directions parallel to the Y axis are referred to as a Y-axis direction, and both directions parallel to the Z axis are referred to as a Z-axis direction.

The method for manufacturing the additively manufactured body illustrated in FIGS. 1 to 10 is a method called a binder jet method, which is a type of an additive manufacturing method, and includes a powder layer forming step S102, a binder solution supplying step S104, and a repeating step S106 as illustrated in FIG. 1. The binder jet method does not need any support structure for supporting a modeled object, and thus has an advantage that an additively manufactured body having a complicated shape can be prepared.

In the powder layer forming step S102, an additive manufacturing powder 1 is spread to form a powder layer 31. In the binder solution supplying step S104, a binder solution 4 is supplied to a predetermined region of the powder layer 31, and particles in the powder layer 31 are bound to each other to obtain a binder layer 41. In the repeating step S106, the powder layer forming step S102 and the binder solution supplying step S104 are repeated once or more to obtain an additively manufactured body 6 illustrated in FIG. 10. Hereinafter, each step will be sequentially described.

The prepared additively manufactured body 6 is subjected to a sintering treatment to form a metal sintered body. Accordingly, the metal sintered body having a complicated shape can be efficiently manufactured. In addition to the binder jet method described above, the additive manufacturing powder according to the present disclosure can also be used in methods for obtaining the additively manufactured body, such as powder bed fusion method, in which a laser beam or an electron beam is irradiated onto the powder layer 31 to melt a part of the powder layer 31.

### 1.1. Additive Manufacturing Apparatus

First, an additive manufacturing apparatus 2 used for manufacturing the additively manufactured body 6 by the binder jet method will be described.

As illustrated in FIGS. 2 to 10, the additive manufacturing apparatus 2 includes an apparatus main body 21 including a powder storage unit 211 and a modeling unit 212, a powder supply elevator 22 provided at the powder storage unit 211, a modeling stage 23 provided at the modeling unit 212, and a coater 24, a roller 25 and liquid supply unit 26 which are movably provided on the apparatus main body 21.

The powder storage unit 211 is a recessed portion provided in the apparatus main body 21 and having an open upper portion. The additive manufacturing powder 1 is stored in the powder storage unit 211. An appropriate amount of the additive manufacturing powder 1 stored in the powder storage unit 211 is supplied to the modeling unit 212 by the coater 24.

The powder supply elevator 22 is disposed at a bottom portion of the powder storage unit 211. The powder supply elevator 22 is movable in an upper-lower direction in a state in which the additive manufacturing powder 1 is placed thereon. By moving the powder supply elevator 22 upward, the additive manufacturing powder 1 placed on the powder supply elevator 22 is pushed up to protrude from the powder storage unit 211. Accordingly, a protruding part of the additive manufacturing powder 1 can be moved toward the modeling unit 212.

The modeling unit 212 is a recessed portion provided in the apparatus main body 21 and having an open upper portion. The modeling stage 23 is disposed inside the modeling unit 212. On the modeling stage 23, the additive manufacturing powder 1 is spread in layers by the coater 24. The modeling stage 23 is movable in the upper-lower direction in a state in which the additive manufacturing powder 1 is spread thereon. By appropriately setting a height of the modeling stage 23, an amount of the additive manufacturing powder 1 spread on the modeling stage 23 can be adjusted.

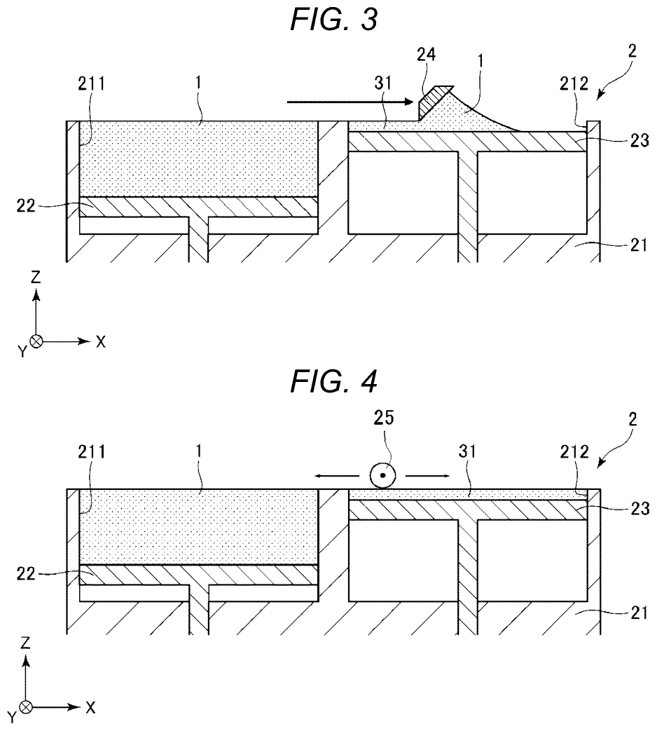

As illustrated in FIGS. 3 and 4, the coater 24 and the roller 25 are movable in the X-axis direction from the powder storage unit 211 to the modeling unit 212. The coater 24 can level and spread the additive manufacturing powder 1 in a layered manner by dragging the additive manufacturing powder 1. The roller 25 compresses the leveled additive manufacturing powder 1 from above.

The liquid supply unit 26 is configured with, for example, an inkjet head and a dispenser, and is movable in the X-axis direction and the Y-axis direction at the modeling unit 212. The liquid supply unit 26 can supply an intended amount of the binder solution 4 to an intended position. The liquid supply unit 26 may include a plurality of ejection nozzles at one head. The binder solution 4 may be ejected simultaneously or with a time difference from the plurality of ejection nozzles.

### 1.2. Powder Layer Forming Step

Next, the powder layer forming step S102 using the additive manufacturing apparatus 2 will be described. In the powder layer forming step S102, the additive manufacturing powder 1 is spread on the modeling stage 23 to form the powder layer 31. Specifically, as illustrated in FIGS. 2 and 3, using the coater 24, the additive manufacturing powder 1 stored in the powder storage unit 211 is dragged onto and leveled on the modeling stage 23 to have a uniform thickness. Accordingly, the powder layer 31 illustrated in FIG. 4 is obtained. At this time, a thickness of the powder layer 31 can be adjusted by lowering an upper surface of the modeling stage 23 below an upper end of the modeling unit 212 and adjusting a lowering amount. As will be described later, the additive manufacturing powder 1 is a powder having excellent fillability when being leveled. Therefore, the powder layer 31 having a high filling ratio can be obtained.

In the formation of the powder layer 31, in addition to the additive manufacturing powder 1, other powders may be used in combination. This further increases the density of the powder layer 31. Examples of the other powders include ceramic powder. Examples of the constituent materials of the ceramic powders include oxide-based ceramics such as aluminum oxide, magnesium oxide, titanium oxide, zirconium oxide, silicon oxide, iron oxide, potassium oxide, sodium oxide, calcium oxide, chromium oxide, and niobium oxide, nitride-based ceramics such as boron nitride and silicon nitride, and silicon carbide, and one or two or more types among these are used.

Next, as illustrated in FIG. 4, the roller 25 is moved in the X-axis direction while compressing the powder layer 31 in a thickness direction by the roller 25. Accordingly, a filling ratio of the additive manufacturing powder 1 in the powder layer 31 can be increased. The compression by the roller 25 may be performed as necessary, and may be omitted. The powder layer 31 may be compressed by a unit different from the roller 25, such as a pressing plate.

### 1.3. Binder Solution Supplying Step

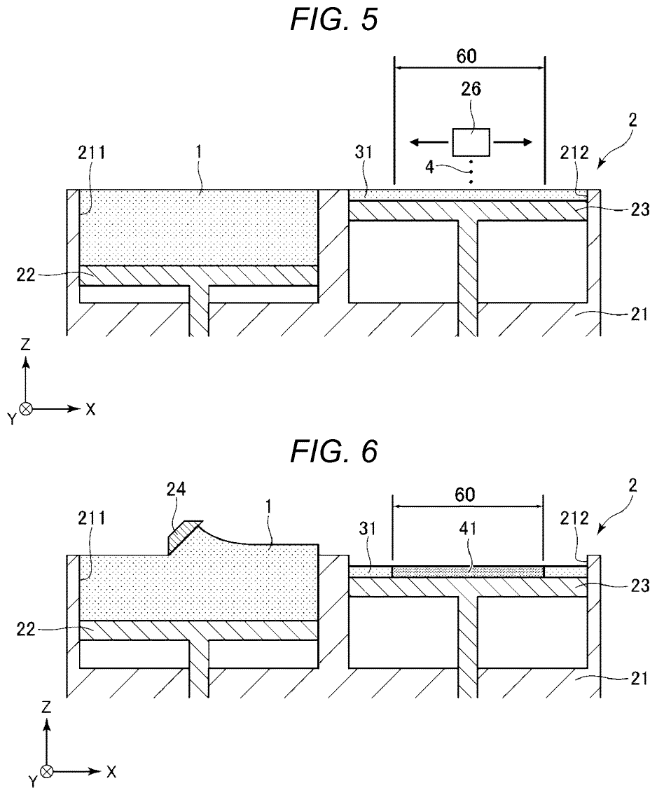

In the binder solution supplying step S104, as illustrated in FIG. 5, the liquid supply unit 26 supplies the binder solution 4 to a forming region 60 corresponding to the additively manufactured body 6 to be shaped in the powder layer 31. The binder solution 4 is, for example, a liquid containing a binder and water (aqueous binder solution). In the forming region 60 to which the binder solution 4 is supplied, particles of the additive manufacturing powder 1 are bound to each other, and the binder layer 41 illustrated in FIG. 6 is obtained. In the binder layer 41, the particles of the additive manufacturing powder 1 are bound to each other by the binder, and the additive manufacturing powder 1 has a shape retention property that is not broken due to its own weight.

The binder layer 41 may be heated simultaneously with or after the supply of the binder solution 4. Accordingly, volatilization of a solvent or a dispersion medium contained in the binder solution 4 is promoted, and solidification or curing of the binder promotes binding of the particles to each other. When the binder contains a photo-curable resin or a UV-curable resin, light irradiation or UV irradiation may be performed instead of heating or together with heating.

A heating temperature during heating is not particularly limited, and is preferably 50° C. or higher and 250° C. or lower, and more preferably 70° C. or higher and 200° C. or lower. Accordingly, a sufficient amount of heat can be applied to the binder layer 41, and the volatilization of the solvent or the dispersion medium can sufficiently be promoted.

The binder solution 4 may contain another solvent together with water. Examples of the solvent include alcohols, ketones, and carboxylic acid esters, and at least one of the above is used. Examples of the binder contained in the binder solution 4 include fatty acids, paraffin waxes, microcrystalline waxes, polyethylene, polypropylene, polystyrene, acrylic resins, polyamide resins, polyesters, stearic acid, polyvinyl pyrrolidone (PVP), polyvinyl alcohol (PVA), polyethylene glycol (PEG), urethane resins, epoxy resins, vinyl resins, unsaturated polyester resins, and phenolic resins.

### 1.4. Repeating Step

In the repeating step S106, the powder layer forming step S102 and the binder solution supplying step S104 are repeated once or more until a stacked body formed by stacking a plurality of the binder layers 41 has a predetermined shape. That is, these steps are performed 2 or more times in total. Accordingly, the three-dimensional additively manufactured body 6 illustrated in FIG. 10 is obtained.

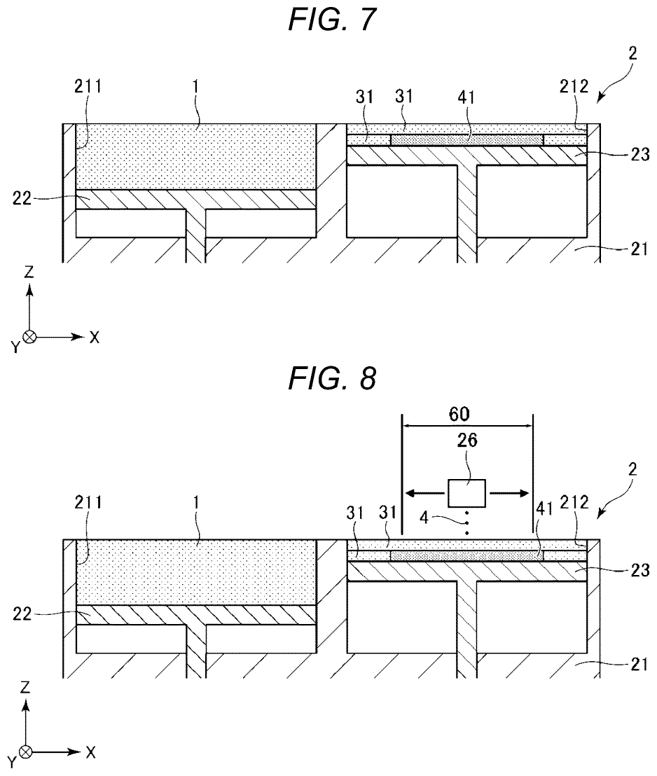

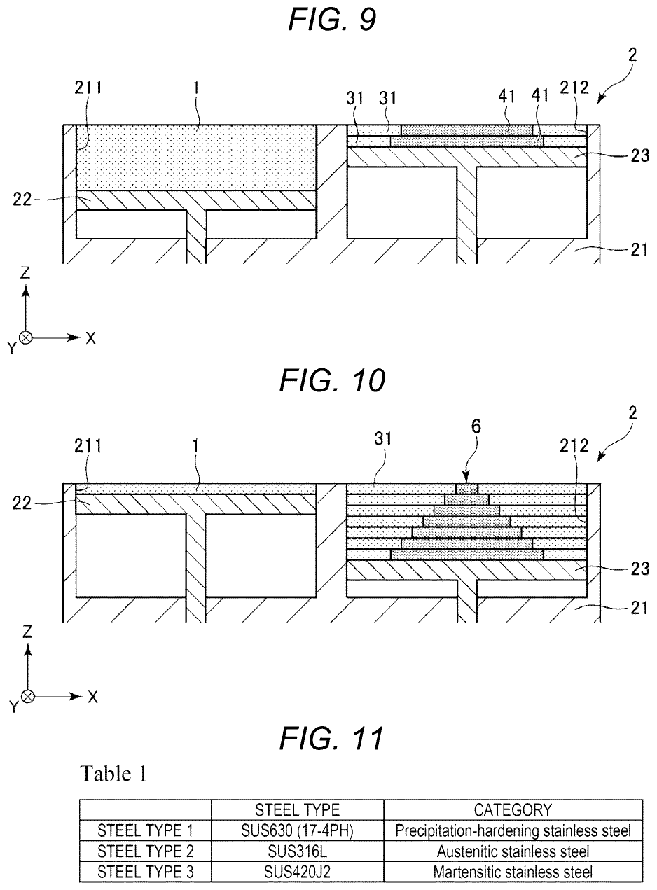

Specifically, first, as illustrated in FIG. 7, a new powder layer 31 is formed at the binder layer 41 illustrated in FIG. 6. Next, as illustrated in FIG. 8, the binder solution 4 is supplied to the forming region 60 in the newly formed powder layer 31. Accordingly, the binder layer 41 as a second layer illustrated in FIG. 9 is obtained. By repeating such operations, the additively manufactured body 6 illustrated in FIG. 10 is obtained.

In the powder layer 31, the additive manufacturing powder 1 that does not constitute the binder layers 41 is collected and reused as necessary, that is, used again for manufacturing the additively manufactured body 6.

The additively manufactured body 6 obtained as described above is, if necessary, subjected to the sintering treatment described below.

### 1.5. Method for Manufacturing Metal Sintered Body

By subjecting the additively manufactured body 6 to the sintering treatment, the metal sintered body is obtained. In the sintering treatment, the additively manufactured body 6 is heated to cause a sintering reaction.

A sintering temperature varies depending on a constituent material, a particle diameter, and the like of the additive manufacturing powder 1, and as an example, is preferably 980° C. or higher and 1330° C. or lower, and more preferably 1050° C. or higher and 1260° C. or lower. A sintering time is preferably 0.2 hours or longer and 7 hours or shorter, and more preferably 1 hour or longer and 6 hours or shorter.

An atmosphere in the sintering treatment is, for example, a reducing atmosphere such as hydrogen, an inert atmosphere such as nitrogen or argon, or a reduced-pressure atmosphere obtained by reducing a pressure of such an atmosphere. The pressure in the reduced-pressure atmosphere is not particularly limited as long as the pressure is lower than a normal pressure (100 kPa), and is preferably 10 kPa or less, and more preferably 1 kPa or less.

When the sintering treatment performed under the above-described conditions is referred to as “main sintering”, “pre-sintering” or “debindering” corresponding to a pretreatment of the main sintering may be performed on the additively manufactured body 6 as necessary. Accordingly, at least a part of the binder contained in the additively manufactured body 6 can be removed, or a sintering reaction can be caused in a portion. Accordingly, when the main sintering is performed, unintended deformation or the like can be prevented.

A temperature in the pre-sintering or the debindering is not particularly limited as long as the temperature is a temperature at which sintering of the additive manufacturing powder 1 is not completed, and is preferably 100° C. or higher and 500° C. or lower, and more preferably 150° C. or higher and 300° C. or lower. A duration of the pre-sintering or the debindering in the temperature range described above is preferably 5 minutes or longer, more preferably 10 minutes or longer and 120 minutes or shorter, and still more preferably 20 minutes or longer and 60 minutes or shorter. An atmosphere in the pre-sintering or the debindering is, for example, an ambient atmosphere, an inert atmosphere such as nitrogen or argon, or a reduced-pressure atmosphere obtained by reducing a pressure of such an atmosphere.

The metal sintered body obtained as described above can be used as a material constituting all or a part of a component for transportation equipment such as a component for an automobile, a component for a bicycle, a component for a railway vehicle, a component for a ship, a component for an aircraft, or a component for a spacecraft, a component for an electronic device such as a component for a personal computer, a component for a mobile phone terminal, a component for a tablet terminal, or a component for a wearable terminal, a component for electrical equipment such as a refrigerator, a washing machine, or a cooling and heating machine, a component for a machine such as a machine tool or a semi-conductor manufacturing apparatus, a component for a plant such as a nuclear power plant, a thermal power plant, a hydroelectric power plant, an oil refinery, or a chemical complex, a component for a timepiece, a metal utensil, and a decorative item such as jewelry or an eyeglass frame.

### 2. Additive Manufacturing Powder

Next, the additive manufacturing powder according to the embodiment will be described.

The additive manufacturing powder 1 according to the present embodiment is a powder particularly suitable for an additive manufacturing method including a formation process of the powder layer 31 such as the binder jet method or the powder bed fusion method.

The additive manufacturing powder 1 according to the present embodiment has a particle diameter D50, at which the cumulative frequency is 50% from the small diameter side, in a cumulative particle size distribution on a volume basis obtained by using a laser diffraction type particle size distribution measuring apparatus, is 1.0 μm or more and 10.0 μm or less. In the above-described cumulative particle size distribution, the particle diameter D90 at which the cumulative frequency is 90% from the small diameter side is 11.0 μm or more and 25.0 μm or less. Further, the specific surface area is 0.30 m²/g or less. The number ratio of particles having a circularity of 0.750 or more and 0.950 or less is 70.0% or more. Furthermore, the coefficient of variation of circularity of particles, obtained by dividing the standard deviation of the circularity of the particles by the average circularity, is 15.0% or less.

According to such a configuration, when the powder layer 31 is formed, it is possible to realize the additive manufacturing powder 1 having good flowability and fillability of the particles. Thus, the dense powder layer 31 can be formed. As a result, the dense additively manufactured body 6 with high modeling accuracy can be manufactured.

### 2.1. Constituent Material

The additive manufacturing powder 1 contains an Fe-based metal material. The Fe-based metal material refers to a metal material having an Fe content of more than 50% in terms of an atomic ratio. By using the Fe-based metal material, the additively manufactured body 6 having a high Fe content can be obtained. The additively manufactured body 6 becomes the metal sintered body having excellent mechanical strength and corrosion resistance derived from Fe, for example, by being sintered.

Examples of the Fe-based metal material include stainless steel such as austenitic stainless steel, ferritic stainless steel, martensitic stainless steel, precipitation-hardening stainless steel, and austenitic-ferritic (duplex) stainless steel, low-carbon steel, carbon steel, heat-resistant steel, die steel, high-speed tool steel, an Fe-Ni alloy, and an Fe—Ni—Co alloy.

Among these, stainless steel is preferably used as the Fe-based metal material. Stainless steel is a steel type having excellent mechanical strength and corrosion resistance. Therefore, by using the additive manufacturing powder 1 made of stainless steel, the metal sintered body having excellent mechanical strength and corrosion resistance and having high shape accuracy can be efficiently manufactured. In addition, the additively manufactured body 6 capable of manufacturing the metal sintered body is obtained.

Among the types of stainless steel, precipitation-hardening stainless steel is particularly preferably used. The precipitation-hardening stainless steel has excellent mechanical strength and toughness due to formation of a precipitate.

Examples of the austenitic stainless steel include SUS301, SUS301L, SUS301J1, SUS302B, SUS303, SUS304, SUS304Cu, SUS304L, SUS304N1, SUS304N2, SUS304LN, SUS304J1, SUS304J2, SUS305, SUS309S, SUS310S, SUS312L, SUS315J1, SUS315J2, SUS316, SUS316L, SUS316N, SUS316LN, SUS316Ti, SUS316J1, SUS316J1L, SUS317, SUS317L, SUS317LN, SUS317J1, SUS317J2, SUS836L, SUS890L, SUS321, SUS347, SUSXM7, and SUSXM15J1.

Examples of the ferritic stainless steel include SUS405, SUS410L, SUS429, SUS430, SUS430LX, SUS430J1L, SUS434, SUS436L, SUS436J1L, SUS445J1, SUS445J2, SUS444, SUS447J1, and SUSXM27.

Examples of the martensitic stainless steel include SUS403, SUS410, SUS410S, SUS420J1, SUS420J2, and SUS440A.

Examples of the precipitation-hardening stainless steel include SUS630 (17-4PH) and SUS631 (17-7PH).

Examples of the austenitic-ferritic (duplex) stainless steel include SUS329J1, SUS329J3L, and SUS329J4L.

The above-described symbols are material symbols based on the JIS standards. The types of stainless steel in the specification are distinguished by the above-described material symbols.

The additive manufacturing powder 1 may be provided with a coating film that covers a surface of a core particle made of the Fe-based metal material. The coating film is provided, for example, for a purpose of enhancing flowability and fillability of the additive manufacturing powder 1, and enhancing affinity between the additive manufacturing powder 1 and the binder. Examples of a constituent material of the coating film include organic materials such as resins, inorganic materials such as ceramics and glass, and compounds derived from a coupling agent.

### 2.2. Various Characteristics of Additive Manufacturing Powder

Next, various characteristics of the additive manufacturing powder 1 will be described. All of the following characteristics are measured in a state in which the additive manufacturing powder 1 is not provided with the above-described coating film.

### 2.2.1. Particle Size Distribution

For the additive manufacturing powder 1 according to the embodiment, when a volume-based particle size distribution is obtained by a laser diffraction type particle size distribution measuring apparatus, a particle diameter when a cumulative frequency is 10% from a small diameter side is defined as D10. Similarly, particle diameters when the cumulative frequency is 50% and 90% from the small diameter side are defined as D50 and D90. An example of the apparatus for measuring the particle size distribution is Microtrac HRA 9320-X100 manufactured by Nikkiso Co., Ltd.

The particle diameter D50 of the additive manufacturing powder 1 is 1.0 μm or more and 10.0 μm or less, preferably 3.0 μm or more and 10.0 μm or less, and more preferably 4.0 μm or more and 9.0 μm or less. Accordingly, both the flowability and the fillability of the additive manufacturing powder 1 can be enhanced. As a result, the dense powder layer 31 can be formed, enabling the obtaining of the dense additively manufactured body 6 with high modeling accuracy. Then, the metal sintered body having high density and high surface accuracy can finally be manufactured using the same.

When the particle diameter D50 is smaller than the lower limit value, particles of the additive manufacturing powder 1 tend to agglomerate with each other. Therefore, the flowability and the fillability of the additive manufacturing powder 1 decrease, and the density of the powder layer 31 decreases. However, when the particle diameter D50 exceeds the upper limit value, the gap between the particles of the additive manufacturing powder 1 increases, and the density of the powder layer 31 decreases.

The particle diameter D90 of the additive manufacturing powder 1 is 11.0 μm or more and 25.0 μm or less, preferably 13.0 μm or more and 24.0 μm or less, and more preferably 15.0 μm or more and 23.0 μm or less. Accordingly, both the flowability and the fillability of the additive manufacturing powder 1 can be enhanced. As a result, the dense additively manufactured body 6 with high modeling accuracy can be obtained. Then, the metal sintered body having high density and high surface accuracy can finally be manufactured using the same.

When the particle diameter D90 is smaller than the lower limit value, the particle size distribution needs to be narrowed, which increases the manufacturing difficulty of the additive manufacturing powder 1 and leads to higher manufacturing costs. However, when the particle diameter D90 exceeds the upper limit value, the gap between the particles of the additive manufacturing powder 1 increases, and the density of the powder layer 31 decreases.

The ratio D10/D50 of the particle diameter D10 to the particle diameter D50 is preferably 0.30 or more and 0.70 or less, more preferably 0.35 or more and 0.60 or less, and still more preferably 0.40 or more and 0.55 or less. Accordingly, the particle size distribution of the additive manufacturing powder 1 is optimized, and flowability and fillability tend to be enhanced. In addition, the sinterability of the additively manufactured body 6 can also be ensured. When the ratio D10/D50 is less than the lower limit value, the particle size distribution is broad, and the flowability may decrease. However, when the ratio D10/D50 exceeds the upper limit value, the particle size distribution is, conversely, excessively narrow, it is difficult to increase the filling ratio, and the sinterability may decrease.

A ratio D90/D50 of the particle diameter D90 to the particle diameter D50 is preferably 1.70 or more and 3.00 or less, more preferably 2.10 or more and 2.90 or less, and still more preferably 2.30 or more and 2.80 or less. Accordingly, the particle size distribution of the additive manufacturing powder 1 is optimized, and flowability and fillability tend to be enhanced. In addition, the sinterability of the additively manufactured body 6 can also be ensured. When the ratio D90/D50 is less than the lower limit value, the particle size distribution is narrow, it is difficult to increase the filling ratio, and the sinterability may decrease. However, when the ratio D90/D50 exceeds the upper limit value, the particle size distribution is broad, and the flowability may decrease.

The particle diameter difference D90-D10 between the particle diameter D90 and the particle diameter D10 is preferably 8.0 μm or more and 24.0 μm or less, more preferably 12.0 μm or more and 22.0 μm or less, and further preferably 14.0 μm or more and 20.0 μm or less. Accordingly, the particle size distribution of the additive manufacturing powder 1 is sufficiently narrow, and high flowability can be obtained. As a result, the fillability of the additive manufacturing powder 1 is improved, and the dense additively manufactured body 6 with high modeling accuracy can be obtained.

When the particle diameter difference D90-D10 is less than the lower limit value, the particle size distribution of the additive manufacturing powder 1 is extremely narrow, thus it is difficult to increase the filling ratio, and the sinterability may decrease. Therefore, the density and the surface accuracy of the metal sintered body to be manufactured may decrease. However, when the particle diameter difference D90-D10 exceeds the upper limit value, the particle size distribution of the additive manufacturing powder 1 is broad, and the flowability may decrease. Therefore, the density and the surface accuracy of the sintered body to be manufactured may decrease.

### 2.2.2. Specific Surface Area

The specific surface area of the additive manufacturing powder 1 is 0.30 m²/g or less, preferably 0.10 [m²/g] or more and 0.25 [m²/g] or less, and more preferably 0.15 [m²/g] or more and 0.22 [m²/g] or less. When the specific surface area is within the above range, the flowability and fillability of the additive manufacturing powder 1 are enhanced, and the dense powder layer 31 is obtained. Accordingly, the dense additively manufactured body 6 with high modeling accuracy is obtained. In addition, the sinterability of the additively manufactured body 6 can also be ensured.

When the specific surface area is less than the lower limit value, the manufacturing difficulty of the additive manufacturing powder 1 may increase. However, when the specific surface area exceeds the upper limit value, the flowability and fillability of the additive manufacturing powder 1 decrease.

The specific surface area of the additive manufacturing powder 1 is obtained using a BET method. As a specific surface area measuring apparatus, for example, a BET type specific surface area measuring apparatus HM1201-010 manufactured by Mountech Co., Ltd. may be used, and a specimen amount is 5 g.

### 2.2.3. Circularity

In the additive manufacturing powder 1, the number ratio of particles having a circularity of 0.750 or more and 0.950 or less is 70.0% or more, preferably 72.0% or more and 90.0% or less, and more preferably 75.0% or more and 85.0% or less. The circularity of the particles of the additive manufacturing powder 1 is acquired as follows.

First, an image (secondary electron image) of the additive manufacturing powder 1 is taken using a scanning electron microscope (SEM). Next, the obtained image is read into image processing software. As the image processing software, for example, image analysis type particle size distribution measurement software “Mac-View” manufactured by Mountech Co., Ltd. is used. An imaging magnification is adjusted such that 50 to 100 particles appear in one image. Then, a plurality of images are acquired to obtain images of a total of 300 or more particles.

Next, the circularity of 300 or more particle images is calculated using software. When a circularity is represented by e, an area of a particle image is represented by S, and a perimeter of the particle image is represented by L, the circularity e is determined using the following formula.

$$e = 4 π S / {L}^{2}$$

Next, the number of particles whose circularity is calculated is defined as the total number of particles. Meanwhile, the number of particles having a circularity of 0.750 or more and 0.950 or less is defined as the specific number of particles. Then, the ratio of the specific number of particles to the total number of particles is calculated, and this is set as the number ratio described above.

When the number ratio is within the above range, the number ratio of the region having a high contribution to the flowability and the fillability increases in the circularity distribution, and thus the flowability and the fillability of the additive manufacturing powder 1 can be enhanced. Accordingly, the dense powder layer 31 can be formed, enabling the obtaining of the dense additively manufactured body 6 with high modeling accuracy. In addition, the manufacturability of the additive manufacturing powder 1 can be ensured. When the number ratio is less than the lower limit value, the flowability and the fillability of the additive manufacturing powder 1 decrease. However, when the number ratio exceeds the upper limit value, the manufacturability of the additive manufacturing powder 1 may decrease.

The average circularity of the additive manufacturing powder 1 is preferably 0.80 or more and less than 1.00, more preferably 0.82 or more and 0.95 or less, and further preferably 0.84 or more and 0.92 or less. Accordingly, even when the particle diameter of the additive manufacturing powder 1 is small, the particles tend to roll, and the filling state tends to approach a close-packed state. As a result, the flowability and the fillability of the additive manufacturing powder 1 can be particularly enhanced. In addition, since the surface energy is optimized, the metal sintered body having high density and high surface accuracy can finally be manufactured.

When the average circularity is less than the lower limit value, the flowability and the filling ratio of the additive manufacturing powder 1 may decrease depending on the circularity distribution. However, when the average circularity exceeds the upper limit value, manufacturing difficulty increases, and the manufacturing efficiency of the additive manufacturing powder 1 may decrease.

The average circularity of the additive manufacturing powder 1 is measured as follows.

First, a total of 300 or more particle images are acquired by the above-described method, and the circularity of each particle image is calculated. Next, an average value of the calculated circularities is obtained. The obtained average value is the average circularity of the additive manufacturing powder 1.

The additive manufacturing powder 1 has the coefficient of variation of circularity of particles of 15.0% or less, preferably 2.0% or more and 12.0% or less, and more preferably 4.0% or more and 10.0% or less. The coefficient of variation of the circularity of the particles of the additive manufacturing powder 1 is acquired as follows.

First, a total of 300 or more particle images are acquired in the same manner as when acquiring the circularity. Next, each circularity is calculated, and the standard deviation of the circularity and the average circularity are calculated. Next, the standard deviation of the circularity is divided by the average circularity to calculate the coefficient of variation.

When the coefficient of variation is within the above range, the additive manufacturing powder 1 having sufficiently small variation in circularity in the circularity distribution can be obtained. The additive manufacturing powder 1 has sufficiently high flowability and fillability, the dense powder layer 31 can be formed. The coefficient of variation may be less than the lower limit value, but manufacturing difficulty increases, and the manufacturing efficiency of the additive manufacturing powder 1 may decrease. However, when the coefficient of variation exceeds the upper limit value, the variation in the circularity increases, and thus the flowability and the fillability of the additive manufacturing powder 1 decrease. Therefore, the denseness of the powder layer 31 decreases.

### 2.2.4. Apparent Density and Tapped Density

An apparent density of the additive manufacturing powder 1 is preferably 2.50 g/cm³ or more and 3.50 g/cm³ or less, more preferably 2.70 g/cm³ or more and 3.40 g/cm³ or less, and still more preferably 2.90 g/cm³ or more and 3.30 g/cm³ or less. When the apparent density is within the above range, favorable fillability can be ensured even in a natural state. Accordingly, when the powder layer 31 is formed using the additive manufacturing powder 1, the powder layer 31 having a high filling ratio can be formed. As a result, the dense additively manufactured body 6 with high modeling accuracy can be obtained.

The apparent density of the additive manufacturing powder 1 is measured according to a metal powder apparent density measurement method specified in JIS Z 2504:2012. In addition, for the measurement of the apparent density, a powder characteristic evaluation apparatus, Powder Tester (registered trademark) PT-X manufactured by Hosokawa Micron Corporation is preferably used. Before the apparent density is measured, the additive manufacturing powder 1 to be measured is preferably left to stand in an environment at a temperature of 25° C. and a relative humidity of 50% for 1 hour or longer.

A tapped density of the additive manufacturing powder 1 is preferably 4.20 g/cm³ or more and 4.90 g/cm³ or less, more preferably 4.30 g/cm³ or more and 4.80 g/cm³ or less, and still more preferably 4.40 g/cm³ or more and 4.70 g/cm³ or less. When the tapped density is within the above range, a high filling ratio can be obtained when the powder layer 31 is leveled by the modeling stage 23 or compressed by the roller 25. Accordingly, the dense additively manufactured body 6 with high modeling accuracy can be obtained.

The tapped density of the additive manufacturing powder 1 is measured by a powder characteristic evaluation apparatus, Powder Tester (registered trademark) PT-X manufactured by Hosokawa Micron Corporation. Before the tapped density is measured, the additive manufacturing powder 1 to be measured is preferably left to stand in an environment at a temperature of 25° C. and a relative humidity of 50% for 1 hour or longer.

A ratio of the tapped density to the apparent density of the additive manufacturing powder 1 is preferably 1.20 or more and 1.75 or less, more preferably 1.30 or more and 1.70 or less, and still more preferably 1.40 or more and 1.60 or less. When the ratio is within the above range, a difference in the filling ratio between the additive manufacturing powder 1 in a natural state and the additive manufacturing powder 1 after vibration, load, or the like is applied can be reduced. Therefore, the flowability and fillability of the additive manufacturing powder 1 can be enhanced, while deformation or the like of the powder layer 31 and the additively manufactured body 6 caused by the differences in the filling ratio can be suppressed.

Although the ratio may be less than the lower limit value, difficulty in stably manufacturing the additive manufacturing powder 1 may increase. However, when the ratio exceeds the upper limit value, the difference in the filling ratio is large, which may cause deformation or the like of the additively manufactured body 6.

### 3. Method for Manufacturing Additive Manufacturing Powder

Next, an example of a method for manufacturing the additive manufacturing powder 1 will be described.

The additive manufacturing powder 1 may be manufactured using any manufacturing method, and is manufactured, for example, using an atomization method. In the atomization method, a molten metal is caused to flow down from a crucible and collide with a fluid such as a liquid or a gas ejected at a high speed. The molten metal colliding with the fluid falls inertially, and therefore, at this time, becomes spherical droplets. As a result, it is possible to manufacture the additive manufacturing powder 1 having a high average circularity and a relatively small specific surface area despite a relatively small diameter. In addition, since the specific surface area is small, the moisture content can be reduced.

Examples of the atomization method include a water atomization method, a gas atomization method, and a rotary water atomization method, depending on a difference in a type of a cooling medium and a device configuration.

Flow rate of the molten metal varies depending on an apparatus size and the like, and is preferably more than 1.0 [kg/min] and 20.0 [kg/min] or less, and more preferably 2.0 [kg/min] or more and 10.0 [kg/min] or less. Accordingly, it is possible to optimize an amount of the molten metal flowing down during a certain time, and thus the additive manufacturing powder 1 having a narrow particle size distribution and being sufficiently spherical can be efficiently manufactured. As a result, it is possible to manufacture the additive manufacturing powder 1 having a high average circularity and a relatively small specific surface area despite a relatively small diameter. In addition, since the specific surface area is small, the moisture content can be reduced.

A temperature (casting temperature) of the molten metal in the crucible is preferably set, with respect to a melting point Tm [° C.] of the constituent material of the additive manufacturing powder 1, to Tm+100° C. or higher and Tm+350° C. or lower, more preferably Tm+180° C. or higher and Tm+320° C. or lower, and still more preferably Tm+250° C. or higher and Tm+300° C. or lower. Accordingly, it is possible to ensure a time during which the molten metal is present longer than that in the related art when the molten metal is atomized and solidified using various atomization methods. As a result, it is possible to manufacture the additive manufacturing powder 1 having a small diameter, a high average circularity and a relatively small specific surface area.

In various atomization methods, an outer diameter of a fine stream when the molten metal flows down is not particularly limited, and is preferably 3.0 mm or less, more preferably 0.3 mm or more and 2.0 mm or less, and still more preferably 0.5 mm or more and 1.5 mm or less. Accordingly, the fluid can be easily and uniformly applied to the molten metal, and thus liquid droplets having an appropriate size can be easily and uniformly scattered. As a result, it is possible to manufacture the additive manufacturing powder 1 having the average particle diameter and the favorable average circularity as described above with a narrow particle size distribution.

Moreover, in the water atomization method, water injected at a high speed is injected in an inverted conical shape, and the molten metal is caused to collide with the vicinity of the apex. Accordingly, the vicinity of a collision point becomes a negative pressure due to a water film, and thus the molten metal becomes finer. In addition, oxidation of the molten metal can be reduced, and spheroidization can be achieved even when the additive manufacturing powder 1 to be manufactured is fine. The negative pressure in the vicinity of the collision point is preferably 10 kPa or more and 150 kPa or less, and more preferably 30 kPa or more and 120 kPa or less. Accordingly, the additive manufacturing powder 1 in which the particle diameter and the circularity are optimized can be efficiently manufactured. In addition, when the negative pressure is increased within this range, miniaturization and spheroidization tend to be promoted.

Further, the apex angle of the injected water (the angle formed inside the apex of the inverted cone) can further reduce the pressure in the vicinity of the collision point formed by the water film, and can prolong the time until the molten metal flowing down reaches the collision point. Accordingly, even when the additive manufacturing powder 1 to be manufactured is fine, spheroidization can be sufficiently achieved. The apex angle of the injected water is preferably 3° or more and 15° or less, and more preferably 5° or more and 10° or less. When the apex angle is reduced within this range, miniaturization and spheroidization tend to be promoted.

In addition, the manufactured additive manufacturing powder 1 may be classified as necessary. Examples of classification methods include dry classification such as sieving classification, inertial classification, and centrifugal classification, and wet classification such as sedimentation classification.

Further, the surface treatment may be performed on the particle surface of the manufactured additive manufacturing powder 1. Examples of the surface treatment include coupling agent treatment.

### 4. Effects of Embodiment

As described above, the additive manufacturing powder 1 according to the embodiment is the additive manufacturing powder 1 used for manufacturing the additively manufactured body 6, in which the particle diameter D50, at which the cumulative frequency is 50% from the small diameter side, in a cumulative particle size distribution on a volume basis obtained by using a laser diffraction type particle size distribution measuring apparatus, is 1.0 μm or more and 10.0 μm or less. In the cumulative particle size distribution, the particle diameter D90 at which the cumulative frequency is 90% from the small diameter side is 11.0 μm or more and 25.0 μm or less. Further, the specific surface area is 0.30 m²/g or less. The number ratio of particles having a circularity of 0.750 or more and 0.950 or less is 70.0% or more. Furthermore, the coefficient of variation of circularity of particles, obtained by dividing the standard deviation of the circularity of the particles by the average circularity, is 15.0% or less.

According to such a configuration, the additive manufacturing powder 1 having good flowability and fillability and capable of forming the dense powder layer 31 is obtained.

In the additive manufacturing powder 1 according to the embodiment, the average circularity is preferably 0.80 or more and less than 1.00.

According to such a configuration, even when the particle diameter of the additive manufacturing powder 1 is small, the particles are easily rolled, and a filling state can be brought close to a close-packed state. As a result, the flowability and the fillability of the additive manufacturing powder 1 can be particularly enhanced.

In the additive manufacturing powder 1 according to the embodiment, the ratio of the tapped density to the apparent density is preferably 1.20 or more and 1.75 or less.

According to such a configuration, the difference in the filling ratio between the additive manufacturing powder 1 in a natural state and the additive manufacturing powder 1 after vibration, load, or the like is applied can be reduced. Therefore, the flowability and fillability of the additive manufacturing powder 1 can be enhanced, while deformation or the like of the powder layer 31 and the additively manufactured body 6 caused by the differences in the filling ratio can be suppressed.

In the additive manufacturing powder 1 according to the embodiment, the constituent material may be an Fe-based metal material.

According to such a configuration, for example, the additively manufactured body 6 capable of manufacturing the metal sintered body having excellent mechanical strength and corrosion resistance derived from Fe by sintering is obtained.

In the additive manufacturing powder 1 according to the embodiment, the Fe-based metal material may be stainless steel.

According to such a configuration, the additively manufactured body 6 capable of efficiently manufacturing the metal sintered body having excellent mechanical strength and corrosion resistance and having high shape accuracy is obtained.

The additively manufactured body 6 according to the embodiment contains the additive manufacturing powder 1 according to the embodiment and the binder that binds particles of the additive manufacturing powder 1 to each other.

According to such a configuration, by using the additive manufacturing powder 1 having high flowability and fillability, the dense additively manufactured body 6 with high modeling accuracy is obtained. Therefore, the metal sintered body having high density and high surface accuracy is obtained by sintering the additively manufactured body 6.

Although the additive manufacturing powder and the additively manufactured body according to the present disclosure are described above based on the illustrated embodiment, the present disclosure is not limited thereto, and for example, the additive manufacturing powder and the additively manufactured body according to the present disclosure may have any configuration added to the embodiment.

### EXAMPLES

Next, specific examples of the present disclosure will be described.

### 5. Manufacturing of Additive Manufacturing Powder

An additive manufacturing powder in each of samples No. 1 to No. 19 was prepared using a water atomization method. Various conditions in the water atomization method are as follows.
Outer diameter of fine stream of molten metal that was allowed to flow down: 3.0 mm
Flow rate of molten metal: 5.0 kg/min
Casting temperature: Tm+270° C.
Negative pressure in the vicinity of the collision point of water: 50 kPa to 100 kPa
Apex angle of water: 5° to 10°

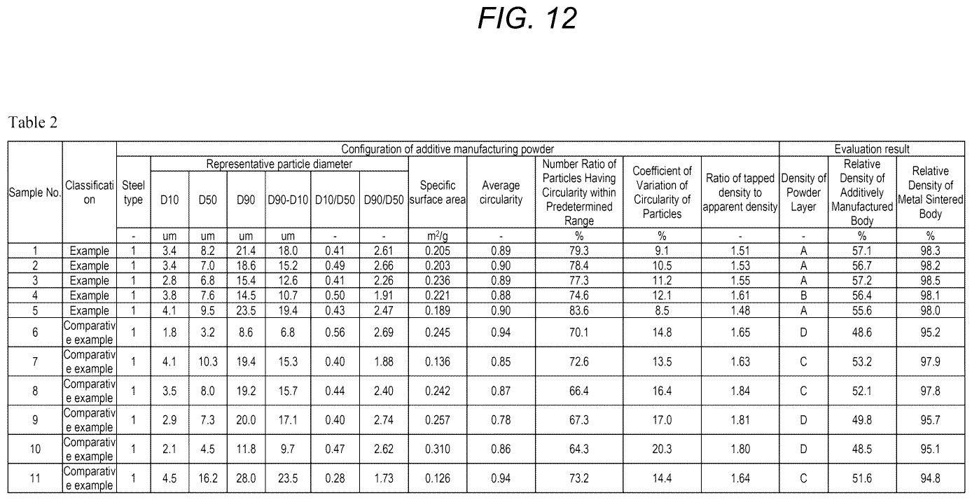

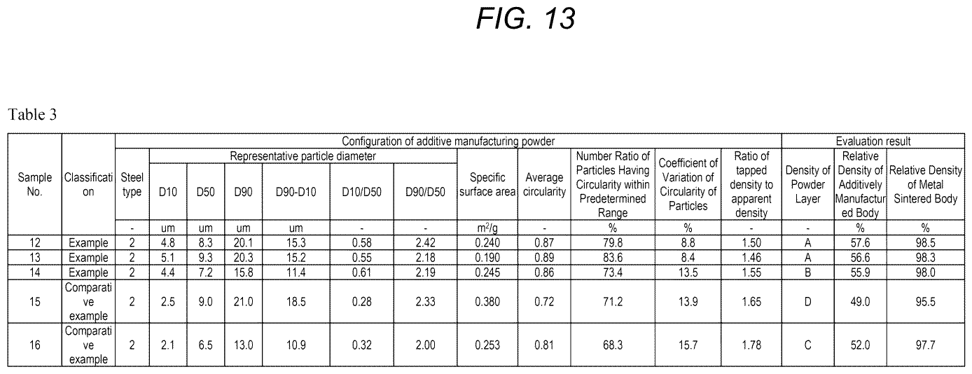

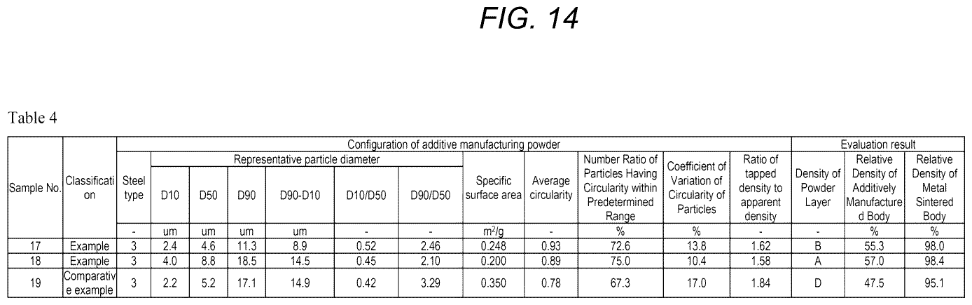

A composition of the additive manufacturing powders in the respective sample Nos. is as shown in Table 1 (FIG. 11) to Table 4 (FIG. 14). FIG. 11 is Table 1 showing the steel types of each additive manufacturing powder. FIG. 12 is Table 2 showing the configuration and evaluation results of each additive manufacturing powder. FIG. 13 is Table 3 showing the configuration and evaluation results of each additive manufacturing powder. FIG. 14 is Table 4 showing the configuration and evaluation results of each additive manufacturing powder.

### 6. Properties of Additive Manufacturing Powder

Table 1 shows the steel types used for each additive manufacturing powder.

For each additive manufacturing powder, the representative particle diameter, the specific surface area, the average circularity, the number ratio of particles having a circularity within a predetermined range of (0.750 or more and 0.950 or less), the coefficient of variation obtained by dividing the standard deviation of the circularity of the particles by the average circularity, and the ratio of tap density to apparent density were measured or calculated. The measurement results and calculation results are shown in Tables 2 to 4. In Tables 2 to 4, among the additive manufacturing powders of the respective sample Nos., those corresponding to the present disclosure were each denoted as “Example”, and those not corresponding to the present disclosure were each denoted as “Comparative example”.

### 7. Evaluation of Additive Manufacturing Powder

### 7.1. Density of Powder Layer

The powder layer was formed by the additive manufacturing apparatus using the additive manufacturing powders and the silica powders (ceramic powders) of the respective sample Nos. The particle diameter D50 of the silica powders was 10 nm. The addition amount of the silica powder was 0.02 parts by mass with respect to 100 parts by mass of the additive manufacturing powder.

Next, the volume and mass of the obtained powder layer were measured, and the density of the powder layer was calculated. Then, the calculated density was evaluated against the following evaluation criteria. Evaluation results are shown in Tables 2 to 4.
A: The density of the powder layer is 4.30 [g/cm³] or more
B: The density of the powder layer is 4.10 [g/cm³] or more and less than 4.30 [g/cm³]
C: The density of the powder layer is 3.90 [g/cm³] or more and less than 4.10 [g/cm³]
D: The density of the powder layer is less than 3.90 g/cm³

### 7.2. Relative Density of Additively Manufactured Body

Using the additive manufacturing powders of the respective sample Nos., an additively manufactured body having a rectangular parallelepiped shape was prepared by the binder jet method. The prepared additively manufactured body had a length of 40 mm, a width of 20 mm, and a thickness of 5 mm. A PVP aqueous solution was used as the binder solution.

Next, the volume and mass of the prepared additively manufactured body and the particle density of the used additive manufacturing powder were measured. A dry automatic density meter capable of measurement by a gas displacement method was used to measure the particle density. Next, the density of the additively manufactured body was calculated based on the volume and the mass, and the relative density of the additively manufactured body was calculated based on the density and the particle density of the obtained additively manufactured body. Calculation results are shown in Tables 2 to 4.

### 7.3. Relative Density of Metal Sintered Body

First, the additively manufactured body prepared in 7.2 was subjected to a debindering treatment to remove the binder, and then was sintered in a furnace. A sintering condition for the steel type 1 was 1100° C.×3 hours in an argon atmosphere. Accordingly, the metal sintered body was obtained. For the steel type 2 and the steel type 3, the sintering condition was selected according to a composition.

Next, the relative density of the metal sintered body was calculated based on the volume and mass of the prepared metal sintered body and the particle density of the used additive manufacturing powder. Calculation results are shown in Tables 2 to 4.

### 7.4. Consideration on Evaluation Results

As shown in Tables 2 to 4, it was confirmed that the high-density powder layer can be formed by using the additive manufacturing powder of each Example. It is considered that this is because the additive manufacturing powder of each Example has good flowability and fillability.

In addition, it was confirmed that the high-density additively manufactured body can be manufactured by using the additive manufacturing powder of each Example.

Further, it was also confirmed that the high-density metal sintered body can be manufactured by sintering the obtained high-density additively manufactured body.

From the above, it was revealed that the additive manufacturing powder according to the present disclosure has good flowability and fillability, can form the dense powder layer, and can be used to manufacture the high-density additively manufactured body and the metal sintered body.

What is claimed is:

1. An additive manufacturing powder used for manufacturing an additively manufactured body: wherein
a particle diameter D50, at which the cumulative frequency is 50% from the small diameter side, in a cumulative particle size distribution on a volume basis obtained by using a laser diffraction type particle size distribution measuring apparatus, is 1.0 μm or more and 10.0 μm or less;
a particle diameter D90, at which the cumulative frequency is 90% from the small diameter side, in the cumulative particle size distribution, is 11.0 μm or more and 25.0 μm or less;
a specific surface area is 0.30 m²/g or less;
a number ratio of particles having a circularity of 0.750 or more and 0.950 or less is 70.0% or more; and
a coefficient of variation of circularity of particles, obtained by dividing a standard deviation of circularity of the particles by the average circularity, is 15.0% or less.

2. The additive manufacturing powder according to claim 1, wherein the average circularity is 0.80 or more and less than 1.00.

3. The additive manufacturing powder according to

1. wherein a ratio of a tapped density to an apparent density is 1.20 or more and 1.75 or less.

4. The additive manufacturing powder according to claim 1, wherein the constituent material is an Fe-based metal material.

5. The additive manufacturing powder according to claim 4, wherein the Fe-based metal material is stainless steel.

6. An additively manufactured body, comprising:
the additive manufacturing powder according to claim 1; and
a binder that binds the particles of the additive manufacturing powder to each other.
